(19) United States
(12) Patent Application Publication
(10) Pub. No.: US 2026/0325999 A1
(43) Pub. Date: Oct. 22, 2026

(54) AIR TREATMENT DEVICE

(71) Applicant: Shenzhen Jingxiang Intelligent Life Technology Co., Ltd., Shenzhen (CN)

(72) Inventors: Lidong Zheng, Shenzhen (CN); Wei Zhang, Shenzhen (CN); Yuxiang Zhu, Shenzhen (CN)

(73) Assignee: Shenzhen Jingxiang Intelligent Life Technology Co., Ltd., Shenzhen (CN)

(21) Appl. No.: 19/693,204

(22) Filed: May 29, 2026

Related U.S. Application Data
(63) Continuation of application No. PCT/CN2024/138777, filed on Dec. 12, 2024.

(30) Foreign Application Priority Data
Dec. 4, 2024 (CN) 202411767841.5

(51) Int. Cl. B01D 37/04; B01D 35/30

(52) U.S. Cl. CPC B01D 37/043; B01D 35/30

(57) ABSTRACT

An air treatment device includes a machine body and an air outlet structure. The machine body includes a purification assembly, a flow guide assembly, and a valve assembly. Air can be purified by the purification assembly and guided by the flow guide assembly to flow out. The flow guide assembly forms a first sub-duct and a second sub-duct, where the air can flow out entirely via the first sub-duct, or via the first sub-duct and the second sub-duct in a split manner.

### FIELD OF TECHNOLOGY

The present disclosure relates to the field of air treatment technology, particularly to an air treatment device.

### BACKGROUND

An air purification device is an electrical appliance capable of effectively improving indoor air quality. It removes pollutants from the air through various purification technologies, such as filter filtration, electrostatic adsorption, and negative ion generation. Its filter can filter out relatively large particles such as dust, pollen, and pet hair, and some advanced filters can also adsorb harmful chemical gaseous pollutants such as formaldehyde and benzene. A negative ion generator can release negative ions, causing tiny particles in the air to become charged, adsorb to each other, agglomerate, and settle, thereby further purifying the air. In environments with severe haze or poor indoor ventilation, an air purifier can rapidly circulate indoor air, creating a relatively healthy and comfortable breathing space for people, thus reducing the harm of allergens and harmful air in the air to the human respiratory tract and other organs. It creates a relatively healthy and clean breathing environment for people.

In existing air purifiers, regardless of the mode, there is typically only one air outlet, making it impossible to change the air outlet based on different modes and usage scenarios, thus resulting in a poor user experience.

### SUMMARY

An objective of a first aspect of the present disclosure is to provide an air treatment device.

In particular, the present disclosure provides an air treatment device, including:
a machine body, where the machine body includes a purification assembly, a flow guide assembly, and a valve assembly, where the purification assembly includes a filter assembly and an air inlet duct defined by the filter assembly; the flow guide assembly is disposed on a side of the air inlet duct, and the flow guide assembly defines a first air outlet duct in communication with the air inlet duct; a first sub-duct and a second sub-duct are formed at a tail end of the first air outlet duct, air entering from the purification assembly first passes through the filter assembly for purification and then enters the first air outlet duct via the air inlet duct, and all the air entering the first air outlet duct flows through the first sub-duct and flows out, or the air entering the first air outlet duct flows entirely through the first sub-duct and the second sub-duct and flows out in a split manner; and the valve assembly is disposed on a front side of the first sub-duct and the second sub-duct, and the valve assembly is controllably closed or opened to control the air to flow out entirely via the first sub-duct, or the air to flow through the first sub-duct and the second sub-duct and flow out in a split manner; and
an air outlet structure, rotatably connected to the machine body, where the air outlet structure includes a second air outlet duct, and the second air outlet duct is in communication with the first sub-duct, so that all the air in the first sub-duct flows to the second air outlet duct and flows out.

Optionally, the filter assembly includes:
a first filter member, provided with mesh holes and defining the air inlet duct, and
a second filter member, disposed an outer side of the first filter member, so that external air first passes through the second filter member for filtration and then flows to the air inlet duct via the first filter member.

Optionally, the valve assembly includes:
a fixing member, including two cylindrical side plates nested with each other, and a connecting plate connecting the two side plates, where the connecting plate is provided with at least one first through hole, a structure enclosed by the side plate on an inner side is in communication with the first sub-duct, and the first through hole of the connecting plate is in communication with the second sub-duct; and
a moving member, disposed on a side of the connecting plate, where the moving member is provided with at least one second through hole, when the moving member is controllably moved to a position where the second through hole at least partially overlaps with the first through hole, the valve assembly is opened, and when the moving member is controllably moved to a position where the second through hole does not overlap with the first through hole at all, the valve assembly is closed.

Optionally, the valve assembly further includes:
a first motor; and
a first gear, connected to an output shaft of the first motor to rotate when driven by the first motor, where
an inner side of the moving member is provided with teeth meshing with the first gear, so that the moving member rotates when driven by the first motor, thereby opening or closing the valve assembly.

Optionally, the machine body further includes:
a second motor; and
a driving member, disposed in the air inlet duct or the first air outlet duct, where the driving member is connected to an output shaft of the second motor to rotate when driven by the second motor, thereby driving external air to flow through the purification assembly, the air inlet duct, and the first air outlet duct and flow out.

Optionally, the machine body further includes:
a third motor;
a second gear, connected to an output shaft of the third motor to rotate when driven by the third motor; and
a rotating member, being annular and connected to the air outlet structure, where an inner side of the rotating member is provided with teeth meshing with the second gear, and the third motor drives the second gear to rotate, thereby driving the rotating member and the air outlet structure to rotate.

Optionally, the machine body further includes a wire reel mechanism, and the wire reel mechanism is disposed at an end of the third motor away from the second gear and rotates synchronously with the air outlet structure when driven by the third motor; and
the wire reel mechanism includes a wire reel, where
the wire reel includes:
a barrier panel, having a middle portion connected to the third motor and provided with a fourth through hole;
a first wiring structure, located on one side surface of the barrier panel; and
a second wiring structure, located on the other side surface of the barrier panel; where
a first cable and a second cable are wound around the first wiring structure and the second wiring structure respectively, and after one of the first cable and the second cable is led to another side of the wire reel via the fourth through hole, the first cable and the second cable are led out from a same side of the wire reel, where the first cable and the second cable are a power cable and a signal cable respectively.

Optionally, the first wiring structure includes a first partition, the first partition is perpendicular to a plane of the barrier panel and formed as an annular structure, and the first cable is wound around the first partition; and
the first partition is provided with a first opening and a second opening, a first channel is provided between the first opening and the second opening, and the first cable wound around the first partition passes through a first fixing member disposed at the first opening and extends along the first channel to the second opening, and is led out by a second fixing member disposed at the second opening.

Optionally, the wire reel mechanism further includes a first cover plate, and the first cover plate covers the first channel to restrict the first cable in the first channel.

Optionally, a side of the first partition away from the barrier panel has a first flange extending along a side facing the first cable.

Optionally, the second wiring structure includes a second partition, and the second partition is perpendicular to the plane of the barrier panel and formed as an annular structure for winding the second cable; and
the second partition is provided with a third opening, a second channel is provided between the third opening and the through hole, and the second cable wound around the second partition passes through the third opening and enters the second channel, and is led to another side of the barrier panel via the through hole.

Optionally, a side of the second partition away from the barrier panel has a second flange extending along a side facing the second cable.

Optionally, the wire reel mechanism further includes:
a second cover plate, where the second cover plate is annular and disposed at a periphery of the barrier panel of the wire reel, and cooperates with the barrier panel to isolate the first cable and the second cable; and the second cover plate is further provided with a third partition facing a side of the first wiring structure;
a third cover plate, where the third cover plate covers a space between the first partition and the third partition to define an accommodating space for accommodating the first cable wound around the first wiring structure; and
a bottom plate, covering a side of the second wiring structure of the wire reel to restrict the second cable wound around the second wiring structure.

Optionally, the air outlet structure includes:
an inner air guide member; and
an outer air guide member, cooperating with the inner air guide member to define the second air outlet duct; where
an outer side wall of the inner air guide member is provided with a first blocking portion and a second blocking portion disposed opposite to each other; and the first blocking portion is located at a position above the inner air guide member, the second blocking portion is located at a position under the inner air guide member, the second air outlet duct is divided by the first blocking portion and the second blocking portion into a third sub-duct and a fourth sub-duct distributed left and right, and the air flowing out of the first sub-duct flows through the third sub-duct and the fourth sub-duct and flows out in a split manner.

Optionally, the air outlet structure further includes:
a first shell, with a surface being substantially an arc surface; and
an air outlet member, including an annular air outlet, where the air outlet surrounds a periphery of the first shell, and the air outlet member is disposed downstream of the second air outlet duct so that air in the second air outlet duct is blown out via the air outlet; an inner side of the air outlet of the air outlet member is further provided with a curved surface, and an inner periphery of the curved surface is connected to the periphery of the first shell; and a curvature of the curved surface is opposite to a curvature of a surface of the first shell, and the curved surface extends inward from the air outlet at an obtuse angle with an air outlet direction to prevent air blown out of the air outlet from converging inward along the surface of the first shell.

Optionally, the air outlet structure further includes at least one flow guide member, and the flow guide member includes:
a mounting portion, where the mounting portion is connected to the inner air guide member and the outer air guide member and in communication with the second air outlet duct; and
a flow guide portion, where the flow guide portion is connected to the air outlet member, and the air in the second air outlet duct sequentially passes through the mounting portion and the flow guide portion and is blown out via the air outlet of the air outlet member; and the flow guide portion is further provided with a plurality of flow guide blades to define a direction of an air flow blown out of the air outlet.

Optionally, the air outlet structure further includes at least one heating assembly, and the heating assembly is disposed at the mounting portion, so that air blown out of the second air outlet duct passes through the heating assembly and is then blown out via the air outlet; and
each heating assembly includes:
a plurality of heating modules, where each of the heating modules includes at least one heating member and first heat dissipation members connected to two sides of the heating member, the heating member extends linearly, and a side of each of the first heat dissipation members connected to the heating member extends linearly; and
a connecting member, connecting the plurality of heating modules to form a structure matching a cross section of the mounting portion.

Optionally, each of the first heat dissipation members is bent to form a structure with a bent cross-section, and each of the first heat dissipation members includes:
a plurality of first bent portions close to a side of the heating member, and the plurality of first bent portions are arranged linearly side by side, so that all the first bent portions contact the heating member; and
a plurality of second bent portions away from a side of the heating member; where
each of the heating modules further includes a second heat dissipation member, a side of each of the second heat dissipation members is connected to each of the second bent portions of the first heat dissipation member, and another side of each of the second heat dissipation members is connected to the connecting member.

Optionally, the connecting member includes a first connecting member and a second connecting member, the first connecting member is connected to the second heat dissipation members on a same side of the plurality of heating modules, and the second connecting member is connected to the second heat dissipation members on another side of the plurality of heating modules.

### BRIEF DESCRIPTION OF THE DRAWINGS

The following will describe some specific embodiments of the present disclosure in detail with reference to the drawings in an exemplary but non-limiting manner. In the drawings, the same reference numerals indicate the same or similar components or parts. Those skilled in the art should understand that these drawings are not necessarily drawn to scale. In the drawings:

FIG. 1 is a schematic structural diagram of an air treatment device according to a specific embodiment of the present disclosure.

FIG. 2 is a schematic cross-sectional view of the air treatment device according to a specific embodiment of the present disclosure.

FIG. 3 is a partial exploded schematic diagram of the air treatment device according to a specific embodiment of the present disclosure.

FIG. 4 is a schematic exploded view of a valve assembly according to a specific embodiment of the present disclosure.

FIG. 5 is a schematic exploded view of the valve assembly according to a specific embodiment of the present disclosure.

FIG. 6 is a partial schematic structural diagram of the air treatment device according to a specific embodiment of the present disclosure.

FIG. 7 is a partial schematic structural diagram of the air treatment device according to a specific embodiment of the present disclosure.

FIG. 8 is a partial structural exploded view of the air treatment device according to a specific embodiment of the present disclosure.

FIG. 9 is a partial schematic structural diagram of the air treatment device according to a specific embodiment of the present disclosure.

FIG. 10 is a schematic structural diagram of a wire reel mechanism according to a specific embodiment of the present disclosure.

FIG. 11 is a schematic structural diagram of a first cable and a second cable being wound around a wire reel according to a specific embodiment of the present disclosure.

FIG. 12 is a schematic structural diagram of the wire reel from an angle according to a specific embodiment of the present disclosure.

FIG. 13 is a schematic structural diagram of the wire reel from another angle according to a specific embodiment of the present disclosure.

FIG. 14 is a schematic structural diagram of the wire reel from still another angle according to a specific embodiment of the present disclosure.

FIG. 15 is a schematic exploded view of the wire reel mechanism according to a specific embodiment of the present disclosure.

FIG. 16 is a schematic cross-sectional view of the wire reel mechanism according to a specific embodiment of the present disclosure.

FIG. 17 is a schematic structural diagram of a second cover plate according to a specific embodiment of the present disclosure.

FIG. 18 is a schematic structural diagram of an air outlet structure according to a specific embodiment of the present disclosure.

FIG. 19 is a schematic cross-sectional view of the air outlet structure according to a specific embodiment of the present disclosure.

FIG. 20 is a schematic cross-sectional view of the air outlet structure according to a specific embodiment of the present disclosure.

FIG. 21 is a schematic structural diagram of an inner air guide member from an angle according to a specific embodiment of the present disclosure.

FIG. 22 is a schematic structural diagram of the inner air guide member from another angle according to a specific embodiment of the present disclosure.

FIG. 23 is a schematic structural diagram of an air outlet member according to a specific embodiment of the present disclosure.

FIG. 24 is a schematic structural diagram of a flow guide member according to a specific embodiment of the present disclosure.

FIG. 25 is a schematic structural diagram of the flow guide member assembled with a heating assembly according to a specific embodiment of the present disclosure.

FIG. 26 is a schematic structural diagram of the heating assembly according to a specific embodiment of the present disclosure.

FIG. 27 is a schematic three-dimensional diagram of the heating assembly according to a specific embodiment of the present disclosure.

FIG. 28 is a partial schematic diagram of the heating assembly according to a specific embodiment of the present disclosure.

### DESCRIPTION OF REFERENCE NUMERALS OF DRAWINGS

air treatment device-100;
machine body-200; housing-201; through hole-202;
purification assembly-210; filter assembly-211; first filter member-2111; second filter member-2112; air inlet duct-212;
flow guide assembly-220; first air outlet duct-221; first sub-duct-222; second sub-duct-223;
valve assembly-230; fixing member-231; side plate-2311; connecting plate-2312; first through hole-2313; third through hole-2314; moving member-232; second through hole-2321; first motor-233; first gear-234;
driving member-240; second motor-250; first air guide member-260; first air guide blade-261; second air guide member-270; second air guide blade-271; third motor-280; second gear-281; rotating member-282;
wire reel mechanism-290; wire reel-291; fourth through hole-2911; first wiring structure-292; first partition-2921; first opening-2922; second opening-2923; first channel-2924; first flange-2925; second wiring structure-293; second partition-2931; third opening-2932; second channel-2933; second flange-2934;
barrier panel-294; first cover plate-295; second cover plate-296; groove-2961; third partition-2962; third cover plate-297; first cable-298; second cable-299; bottom plate-2901;
air outlet structure-300;
second air outlet duct-310; third sub-duct-311; fourth sub-duct-312;
inner air guide member-320; first blocking portion-321; first flow guide surface-3211; second blocking portion-322; second flow guide surface-3221;
outer air guide member-330; first shell-340; air outlet member-350; air outlet-351; curved surface-352; flow guide member-360; mounting portion-361; flow guide portion-362; flow guide blade-363;
heating assembly-370; heating module-371; heating member-3711; first heat dissipation member-3712; first bent portion-3713; second bent portion-3714; second heat dissipation member-3715; connecting member-372; first connecting member-3721; and second connecting member-3722.

### DESCRIPTION OF THE EMBODIMENTS

In the description of the embodiments, it should be understood that the terms “length,” “width,” “height,” “upper,” “lower,” “left,” “right,” “vertical,” “horizontal,” “bottom,” “inner,” “outer,” “front,” and “rear” indicating orientation or positional relationships are based on the orientation or positional relationships shown in the drawings, solely for the convenience of describing the present disclosure and simplifying the description, and do not indicate or imply that the referred device or element must have a specific orientation, be constructed or operated in a specific orientation, and thus should not be construed as limiting the present disclosure.

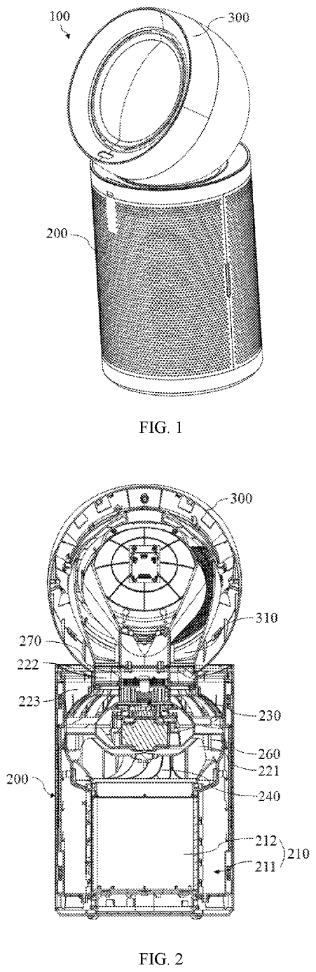

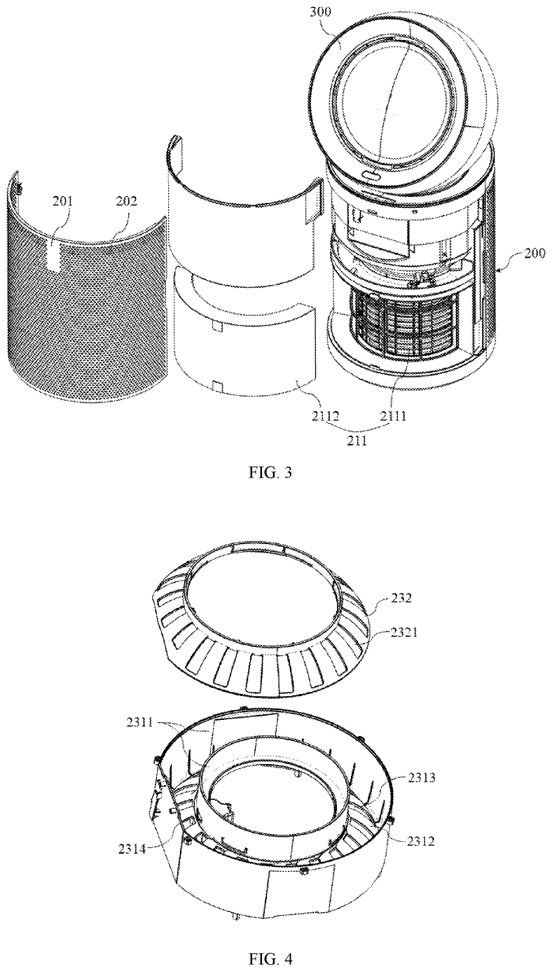

According to a specific embodiment of the present disclosure, as shown in FIGS. 1 to 3, an air treatment device 100 is provided. The air treatment device 100 may include a machine body 200 and an air outlet structure 300. The machine body 200 may include a purification assembly 210, a flow guide assembly 220, and a valve assembly 230, and the purification assembly 210 may include a filter assembly 211 and an air inlet duct 212 defined by the filter assembly 211. The flow guide assembly 220 is disposed on a side of the air inlet duct 212, and the flow guide assembly 220 defines a first air outlet duct 221 in communication with the air inlet duct 212. A first sub-duct 222 and a second sub-duct 223 are formed at a tail end of the first air outlet duct 221, air entering from the purification assembly 210 first passes through the filter assembly 211 for purification and then enters the first air outlet duct 221 via the air inlet duct 212, and the air entering the first air outlet duct 221 flows entirely through the first sub-duct 222 and flows out, or the air entering the first air outlet duct 221 flows through the first sub-duct 222 and the second sub-duct 223 and flows out in a split manner. The valve assembly 230 is disposed on a front side of the first sub-duct 222 and the second sub-duct 223, and the valve assembly 230 is controllably closed or opened to control the air to flow out entirely via the first sub-duct 222, or the air to flow through the first sub-duct 222 and the second sub-duct 223 and flow out in a split manner. The air outlet structure 300 is rotatably connected to the machine body 200, the air outlet structure 300 may include a second air outlet duct 310, and the second air outlet duct 310 is in communication with the first sub-duct 222, so that all the air in the first sub-duct 222 flows to the second air outlet duct 310 and flows out.

Specifically, the air treatment device 100 of this embodiment may include the machine body 200 and the air outlet structure 300, and the machine body 200 may further include the purification assembly 210, the flow guide assembly 220, and the valve assembly 230. Air can be purified by the purification assembly 210 and guided by the flow guide assembly 220 to flow out. The flow guide assembly 220 forms a first sub-duct 222 and a second sub-duct 223, where the air can flow out entirely via the first sub-duct 222 or via the first sub-duct 222 and the second sub-duct 223 in a split manner. When the air entirely flows out of the first sub-duct 222, the air has a high air speed, achieving a blowing effect. When the air flows out via the first sub-duct 222 and the second sub-duct 223 in a split manner, air flowing out of the first air outlet duct 221 has a lower air speed but a larger air volume, resulting in a better purification effect in a regional space. Therefore, the air treatment device 100 of the present disclosure can select different airflow paths based on an operating mode, directing the air toward different outlets, thereby improving the user experience.

According to a specific embodiment of the present disclosure, the filter assembly 211 of this embodiment may include a first filter member 2111 and a second filter member 2112. The first filter member 2111 is provided with mesh holes and defines the air inlet duct 212. The second filter member 2112 is disposed on an outer side of the first filter member 2111, so that external air first passes through the second filter member 2112 for filtration and then flows to the air inlet duct 212 via the first filter member 2111.

Specifically, the second filter member 2112 of this embodiment may be a HEPA (High Efficiency Particulate Air Filter). HEPA means a high-efficiency air filter, which is a type of filtering equipment capable of effectively removing particles from the air. For particles larger than 0.3 micrometers, the HEPA filter can achieve an efficiency of 99.97%. The purification assembly 210 of this embodiment may include the first filter member 2111 and the second filter member 2112, where external air first passes through the second filter member 2112, then through the first filter member 2111, and subsequently flows to the flow guide assembly 220. Specifically, the machine body 200 further includes a housing 201, and the housing 201 surrounds the second filter member 2112. The housing 201 is provided with a plurality of through holes 202, and air first passes through the through holes 202 of the housing 201 before flowing to the second filter member 2112.

Specifically, the first sub-duct 222 and the second sub-duct 223 of this embodiment are both annular, and the second sub-duct 223 is located on an inner side of the first sub-duct 222, thereby enabling the flow rate of air directed to the first sub-duct 222 to be greater than that directed to the second sub-duct 223. The air blown out of the second sub-duct 223 can purify the air within the area space. The air blown out of the first sub-duct 222, with a high air speed, can serve a blowing function.

According to a specific embodiment of the present disclosure, as shown in FIGS. 4 and 5, the valve assembly 230 of this embodiment may include a fixing member 231 and a moving member 232. The fixing member 231 may include two cylindrical side plates 2311 nested with each other, and a connecting plate 2312 connecting the two side plates 2311, the connecting plate 2312 being provided with at least one first through hole 2313. A structure enclosed by the side plate 2311 on an inner side is in communication with the first sub-duct 222, and the first through hole 2313 of the connecting plate 2312 is in communication with the second sub-duct 223. The moving member 232 is disposed on a side of the connecting plate 2312, the moving member 232 is provided with at least one second through hole 2321, when the moving member 232 is controllably moved to a position where the second through hole 2321 at least partially overlaps with the first through hole 2313, the valve assembly 230 is opened, and when the moving member 232 is controllably moved to a position where the second through hole 2321 does not overlap with the first through hole 2313 at all, the valve assembly 230 is closed.

The machine body 200 of this embodiment is provided with the valve assembly 230, and the valve assembly 230 can control the air to flow toward the first sub-duct 222 or toward the first sub-duct 222 and the second sub-duct 223 in a split manner, thereby controlling air flow through the valve assembly 230 to control the operating mode of the air treatment device 100.

The valve assembly 230 of this embodiment may include the fixing member 231 and the moving member 232, where the rotation of the moving member 232 can be controlled to make the first through hole 2313 in the fixing member 231 coincide with or separate from the second through hole 2321 in the moving member 232, thereby opening or closing the second sub-duct 223.

According to a specific embodiment of the present disclosure, the valve assembly 230 of this embodiment may further include a first motor 233 and a first gear 234. The first gear 234 is connected to an output shaft of the first motor 233 to rotate when driven by the first motor 233. An inner side of the moving member 232 is provided with teeth meshing with the first gear 234, so that the moving member 232 rotates when driven by the first motor 233, thereby opening or closing the valve assembly 230.

Specifically, in this embodiment, the first motor 233 drives the first gear 234 to rotate, and the first gear 234 meshes with the teeth on the moving member 232, thereby driving the moving member 232 to rotate via the motor, thus opening and closing the valve.

Specifically, the moving member 232 of this embodiment is disposed above the connecting plate 2312 of the fixing member 231 and sleeves the inner side plate 2311. Since the first gear 234 needs to mesh with the teeth inside the moving member 232, a third through hole 2314 needs to be provided at the inner side plate 2311 of the fixing member 231, the first gear 234 is located on a side of the third through hole 2314, and the teeth of the first gear 234 pass through the third through hole 2314 to mesh with the teeth on the moving member 232.

Specifically, the first through holes 2313 and the second through holes 2321 in this embodiment are plural and equal in number. When the valve assembly 230 is fully opened, the structures of the first through holes 2313 and the second through holes 2321 that overlap are identical.

Specifically, a plurality of first through holes 2313 are provided in this embodiment, and they are substantially rectangular in structure. The number of the second through holes 2321 is the same as that of the first through holes 2313, and the shape of the second through hole 2321 is also substantially the same as that of the first through hole 2313. A certain spacing is maintained between two of the first through holes 2313, the spacing being greater than or equal to the width of the first through hole 2313. Similarly, a certain spacing is maintained between two of the second through holes 2321, the spacing being greater than or equal to the width of the second through hole 2321. When the valve assembly 230 is closed, the second through hole 2321 is completely located between two first through holes 2313. Similarly, the first through hole 2313 is also completely located between two second through holes 2321. In this case, air can only flow through the interior of the inner side plate 2311 to the first sub-duct 222. When the moving member 232 is driven to move so that the first through holes 2313 and the second through holes 2321 overlap, the valve assembly 230 is opened. In this case, air flows partially from the interior of the inner side plate 2311 to the first sub-duct 222 and partially through the first through holes 2313 and the second through holes 2321 to the second sub-duct 223.

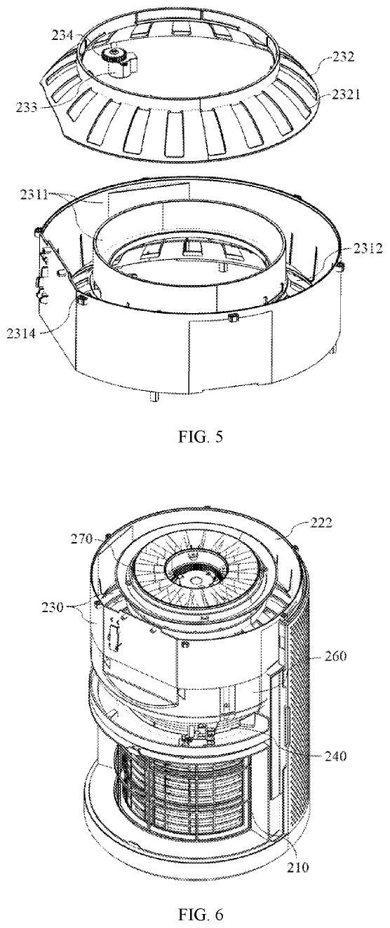

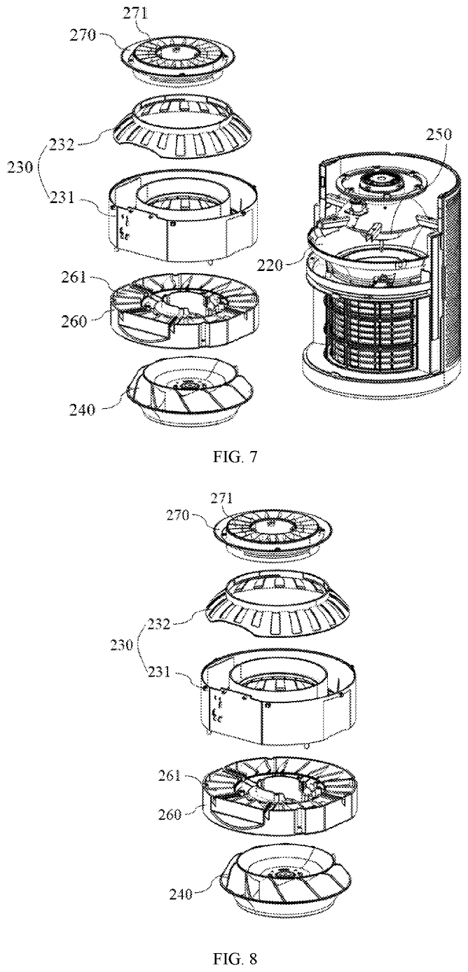

According to a specific embodiment of the present disclosure, as shown in FIGS. 6 to 8, the machine body 200 of this embodiment may further include a second motor 250 and a driving member 240. The driving member 240 is disposed in the air inlet duct 212 or the first air outlet duct 221. The driving member 240 is connected to an output shaft of the second motor 250 to rotate when driven by the second motor 250, thereby driving external air to flow through the purification assembly 210, the air inlet duct 212, and the first air outlet duct 221 and flow out.

Specifically, the driving member 240 in this embodiment is disposed within the first air outlet duct 221 and is located at a position upstream of the first sub-duct 222 and the second sub-duct 223. This allows the driving member 240, when rotated by the second motor 250, to blow air from the air inlet duct 212 entirely toward the first sub-duct 222 or toward the first sub-duct 222 and the second sub-duct 223 in a split manner, and then flow out of the air treatment device 100.

Specifically, as shown in FIGS. 6 to 8, a first air guide member 260 is disposed within the first air outlet duct 221, upstream of the first sub-duct 222 and the second sub-duct 223, the first air guide member 260 is provided with a plurality of first air guide blades 261, and the inclination angles of the plurality of first air guide blades 261 are consistent. Air flowing into the first air outlet duct 221 is guided by the first air guide member 260 and then flows entirely toward the first sub-duct 222 or toward the first sub-duct 222 and the second sub-duct 223 in a split manner, thereby optimizing the internal flow field.

Specifically, as shown in FIGS. 6 to 8, a second air guide member 270 is disposed within the first sub-duct 222 of this embodiment, and the second air guide member 270 is located at a position near the air outlet structure 300 of the first sub-duct 222. The second air guide member 270 includes a plurality of second air guide blades 271, and air entering the first sub-duct 222 is guided by the second air guide member 270 before entering the air outlet structure 300, thereby optimizing the flow field inside the air outlet structure 300.

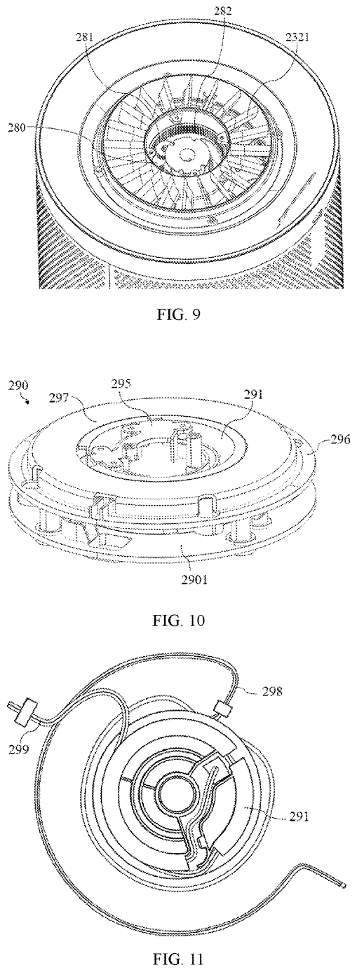

According to a specific embodiment of the present disclosure, as shown in FIG. 9, the machine body 200 of this embodiment may further include a third motor 280, a second gear 281, and a rotating member 282. The second gear 281 connected to an output shaft of the third motor 280 to rotate when driven by the third motor 280. The rotating member 282 is annular and connected to the air outlet structure 300. An inner side of the rotating member 282 is provided with teeth meshing with the second gear 281, and the third motor 280 drives the second gear 281 to rotate, thereby driving the rotating member 282 and the air outlet structure 300 to rotate.

Specifically, the rotating member 282 of this embodiment is connected to the second air guide member 270, so that the second air guide member 270 is driven to move while the rotating member 282 rotates under the driving of the third motor 280. In other words, the second air guide member 270 remains relatively stationary with respect to the air outlet structure 300, thus improving the flow field of the air ducts inside the air outlet structure 300.

Specifically, the third motor 280 of this embodiment drives the second gear 281 to rotate, the second gear 281 drives the rotating member 282 to rotate, and the rotating member 282 is connected to the air outlet structure 300. The rotating member 282 can drive the air outlet structure 300 to rotate, allowing the air outlet structure 300 to rotate relative to the machine body 200, thereby enabling the air blown out of the air outlet structure 300 to be blown out in a rotating manner, to increase the blowing area and enhance the purification effect.

According to a specific embodiment of the present disclosure, as shown in FIGS. 10 to 13, the machine body 200 of this embodiment may further include a wire reel mechanism 290, and the wire reel mechanism 290 is disposed at an end of the third motor 280 away from the second gear 281 and rotates synchronously with the air outlet structure 300 when driven by the third motor 280. The wire reel mechanism 290 may include a wire reel 291, and the wire reel 291 may include a barrier panel 294, a first wiring structure 292, and a second wiring structure 293. The barrier panel 294 has a middle portion connected to the third motor 280 and is provided with a fourth through hole 2911. The first wiring structure 292 is located on one side surface of the barrier panel 294. The second wiring structure 293 is located on the other side surface of the barrier panel 294. A first cable 298 and a second cable 299 are wound around the first wiring structure 292 and the second wiring structure 293 respectively, and after one of the first cable 298 and the second cable 299 is led to another side of the wire reel 291 via the fourth through hole 2911, the first cable 298 and the second cable 299 are led out from a same side of the wire reel 291. The first cable 298 and the second cable 299 are a power cable and a signal cable respectively.

Specifically, generally, the barrier panel 294 has two opposite-facing side surfaces, the first wiring structure 292 and the second wiring structure 293 are respectively arranged on the two side surfaces of the barrier panel 294, the first cable 298 is wound around the first wiring structure 292, and the second cable 299 is wound around the second wiring structure 293. In other words, the first cable 298 and the second cable 299 are respectively arranged on opposite sides of the barrier panel 294 via the first wiring structure 292 and the second wiring structure 293, and the first cable 298 and the second cable 299 are separated by the barrier panel 294.

In some embodiments, both the first cable 298 and the second cable 299 are led out from the side of the wire reel 291 where the first cable 298 is located, and the second cable 299 passes through the fourth through hole 2911 in the barrier panel 294 and is led out from the side of the wire reel 291 where the first cable 298 is located, so that both the first cable 298 and the second cable 299 are connected to the air outlet structure 300, allowing both the first cable 298 and the second cable 299 in the wire reel mechanism 290 to rotate to be loosened or tightened under the driving of the third motor. Specifically, one end of the first cable 298 is fixed in the wire reel 291, and the other end can be led out from the side of the wire reel 291 where the first cable 298 is located, while one end of the second cable 299 is fixed in the wire reel 291, and the other end can be led out via the fourth through hole 2911 to the side of the wire reel 291 where the first cable 298 is located. Thus, when the wire reel mechanism 290 rotates, it can simultaneously tighten or loosen the first cable 298 and the second cable 299.

In some embodiments, the first cable 298 is a power cable, and the second cable 299 is a signal cable. In some other embodiments, the first cable 298 is a signal cable, and the second cable 299 is a power cable, which may be set depending on actual conditions.

Embodiments of the present disclosure provide the first cable 298 and the second cable 299 respectively on two sides of the barrier panel 294, enabling the first cable 298 and the second cable 299 to be separated and located in two isolated regions, thus avoiding interference between the first cable 298 and the second cable 299. The fourth through hole 2911 is provided in the barrier panel 294, allowing the first cable 298 and the second cable 299 to be led out from the same side of the wire reel 291, achieving separation of power and signal cables in the wire reel mechanism 290, and enabling simultaneous rotation of the power cable and the signal cable, thereby enhancing the functional design of the wire reel mechanism 290 and improving the functionality and practicality of the wire reel mechanism 290.

In this embodiment, the wire reel mechanism 290 neatly accommodates the first cable 298 and the second cable 299, preventing cable clutter, effectively reducing wear and damage to the cables, and extending the service life of the cables. The first cable 298 and the second cable 299, after being led out from the wire reel mechanism 290, are separately connected to a rotating mechanism, so that when the rotating mechanism rotates, it drives the first cable 298 and the second cable 299 to rotate together, allowing the first cable 298 and the second cable 299 to be pulled out or retracted together, thus improving the operational efficiency of the cables.

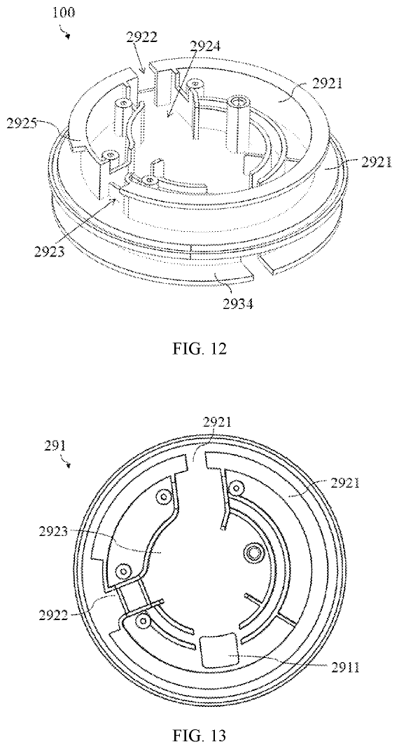

According to a specific embodiment of the present disclosure, as shown in FIGS. 12 and 13, the first wiring structure 292 of this embodiment may include a first partition 2921, the first partition 2921 is perpendicular to a plane of the barrier panel 294 and formed as an annular structure, and the first cable 298 is wound around the first partition 2921. Specifically, the extension direction of the barrier panel 294 is horizontal, the first partition 2921 extends vertically and is arranged in a circular annular shape, and the first cable 298 is wound around the outer peripheral side of the first partition 2921, so that the first cable 298 is loosened or tightened around the first wiring structure 292 when following the rotation of the rotating mechanism. The first partition 2921 guides and restricts the winding of the first cable 298, keeping the first cable 298 neat and preventing the first cable 298 from being disorderly distributed in the wire reel mechanism 290.

Certainly, in other embodiments, the first partition 2921 may be arranged obliquely relative to a plane where the barrier panel 294 is located or have an arc-shaped cross-section, with no specific structural limitation, as long as the first partition 2921 can allow the first cable 298 to be wound.

Specifically, the first partition 2921 is provided with a first opening 2922 and a second opening 2923, a first channel 2924 is provided between the first opening 2922 and the second opening 2923, and the first cable 298 wound around the first partition 2921 passes through a first fixing member disposed at the first opening 2922 and extends along the first channel 2924 to the second opening 2923, and is led out by a second fixing member disposed at the second opening 2923.

It can be understood that the first fixing member and the second fixing member fix a portion of the first cable 298 within the first channel 2924, this portion being located on the inner side of the annular first partition 2921, while other portions of the first cable 298 are wound around the outer side of the annular first partition 2921. This ensures that the first cable 298 remains stable during winding and releasing, preventing the first cable 298 from slipping off the wire reel mechanism 290. In this embodiment, fixing the first cable 298 can also reduce wear and damage to the first cable 298 during winding and releasing, helping to extend the service life of the first cable 298.

In this embodiment, providing the first opening 2922 and the second opening 2923 in the first partition 2921, and providing a first fixing member at the first opening 2922 and a second fixing member at the second opening 2923 allow the first cable 298 to enter the inner side of the annular first partition 2921 and a portion of the first cable 298 to be fixed within the first channel 2924, thereby securing a portion of the first cable 298 in the wire reel mechanism 290, so that when the first cable 298 follows the rotation of the rotating mechanism, the first cable 298 can be stably loosened or tightened, thereby improving the stability and practicality of the wire reel mechanism 290.

According to a specific embodiment of the present disclosure, as shown in FIGS. 10, 15, and 16, the wire reel mechanism 290 of this embodiment may further include a first cover plate 295, and the first cover plate 295 covers the first channel 2924 to restrict the first cable 298 within the first channel 2924.

Above the first cable 298 within the first channel 2924 is the first cover plate 295, and below it is the barrier panel 294. The first cover plate 295 cooperates with the barrier panel 294 to restrict the vertical displacement of the first cable 298, thereby ensuring the stability of the first cable 298 within the first channel 2924, effectively preventing the first cable 298 from slipping or detaching from the wire reel mechanism 290.

According to a specific embodiment of the present disclosure, as shown in FIGS. 12 and 13, a side of the first partition 2921 away from the barrier panel 294 has a first flange 2925 extending along a side facing the first cable 298. Specifically, the bottom of the first partition 2921 is connected to the barrier panel 294, and the top extends outward toward the outer side of the annular first partition 2921 to form the first flange 2925. Thus, the first flange 2925, together with the first partition 2921 and the barrier panel 294, forms an annular groove for winding the first cable 298, and the first flange 2925 enhances the restriction of the wire reel 291 on the first cable 298, preventing the first cable 298 from coming loose or disconnecting above the first partition 2921, and allowing the first cable 298 to be stably mounted in the annular groove, thereby improving the stability and practicality of the wire reel mechanism 290.

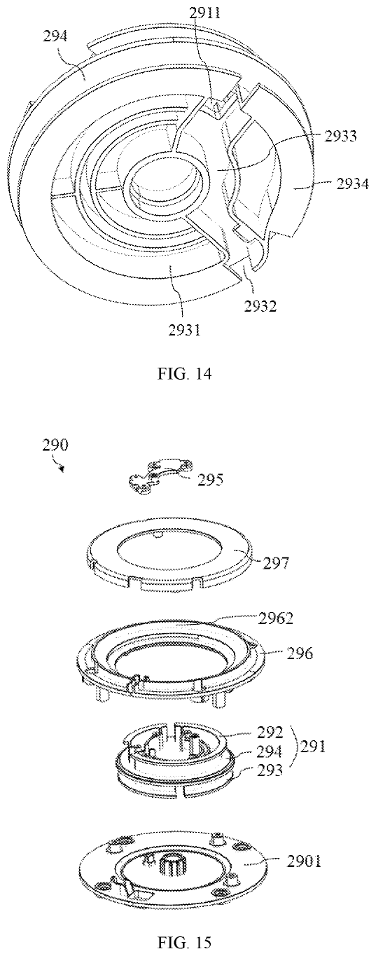

According to a specific embodiment of the present disclosure, as shown in FIG. 14, the second wiring structure 293 of this embodiment may include a second partition 2931, and the second partition 2931 is perpendicular to a plane of the barrier panel 294 and formed as an annular structure for winding the second cable 299. Specifically, the extension direction of the barrier panel 294 is horizontal, the first partition 2921 extends vertically and is arranged in a circular annular shape, and the second cable 299 is wound around the outer peripheral side of the second partition 2931, so that the second cable 299 is loosened or tightened around the second wiring structure 293 when following the rotation of the rotating mechanism. In this embodiment, the second partition 2931 guides and restricts the winding of the second cable 299, keeping the second cable 299 neat and preventing the second cable 299 from being disorderly distributed in the wire reel mechanism 290.

According to a specific embodiment of the present disclosure, the second partition 2931 of this embodiment is provided with a third opening 2932, a second channel 2933 is provided between the third opening 2932 and the fourth through hole 2911, and the second cable 299 wound around the second partition 2931 passes through the third opening 2932, enters the second channel 2933, and is led to the other side of the barrier panel 294 via the fourth through hole 2911. The second channel 2933 guides the second cable 299, improving the operational efficiency of leading the second cable 299 from the fourth through hole 2911 to the other side of the barrier panel 294.

In this embodiment, the second cable 299 is led through the second channel 2933 to the fourth through hole 2911 and out to the other side of the barrier panel 294, allowing the first cable 298 and the second cable 299 on the wire reel mechanism 290 to be led out from the same side and separately connected to the rotating mechanism, thus enabling the wire reel mechanism 290 to accommodate both the first cable 298 and the second cable 299 simultaneously. This allows the wire reel mechanism 290 to achieve the functions of both the first cable 298 and the second cable 299, thus achieving separation of power and signal cables in the wire reel mechanism 290, enabling simultaneous rotation of the power cable and the signal cable, and improving the functionality and practicality of the wire reel mechanism 290.

In some embodiments, a third fixing member is provided at the fourth through hole 2911, allowing the second cable 299 wound around the second partition 2931 to pass through the third fixing member and reach the other side of the barrier panel 294 before being led out of the wire reel 291. This prevents the second cable 299 from slipping, contributing to the stability of the second cable 299.

In some embodiments, the third fixing member may be a tail clip, which can securely fix the second cable 299, preventing the second cable 299 from loosening or detaching, thus ensuring the normal operation of the wire reel mechanism 290. In some other embodiments, the third fixing member may also be other structural components capable of fixing the second cable 299.

According to a specific embodiment of the present disclosure, a side of the second partition 2931 of this embodiment away from the barrier panel 294 has a second flange 2934 extending along a side facing the second cable 299. Thus, the second flange 2934, together with the second partition 2931 and the barrier panel 294, forms an annular groove for winding the second cable 299, and the second flange 2934 enhances the restriction of the wire reel 291 on the second cable 299, preventing the second cable 299 from slipping or coming loose under the second partition 2931, and allowing the second cable 299 to be stably mounted in the annular groove, thereby improving the stability and practicality of the wire reel mechanism 290.

According to a specific embodiment of the present disclosure, as shown in FIGS. 10, 15, and 16, the wire reel mechanism 290 of this embodiment may further include a second cover plate 296, and the second cover plate 296 is annular and disposed at a periphery of the barrier panel 294 of the wire reel 291, and cooperates with the barrier panel 294 to isolate the first cable 298 and the second cable 299. The second cover plate 296 is annularly arranged on the outer peripheral side of the barrier panel 294, restricting the displacement of the first cable 298 toward the outer side of the annular first wiring structure 292, and also restricting the displacement of the second cable 299 toward the outer side of the second wiring structure 293. This prevents the first cable 298 and the second cable 299 from detaching from the wire reel mechanism 290, improving the stability of the wire reel mechanism 290.

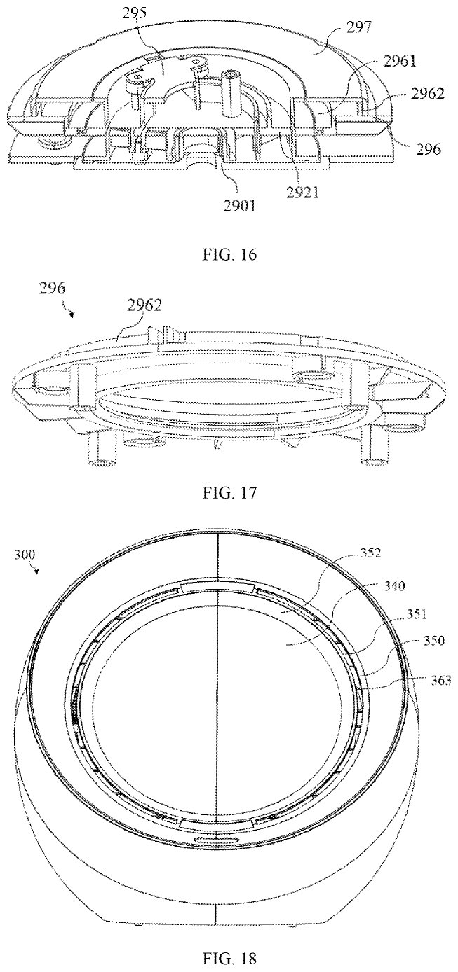

It can be understood that, as shown in FIG. 16, the second cover plate 296, together with the barrier panel 294 and the first partition 2921, forms a groove 2961 for mounting the first cable 298, and the second cover plate 296, together with the barrier panel 294 and the second partition 2931, forms a groove 2961 for mounting the second cable 299, allowing the first cable 298 and the second cable 299 to be stably arranged in the opposite side regions of the barrier panel, and ensuring that the first cable 298 and the second cable 299 are isolated from each other, thus avoiding interference between the first cable 298 and the second cable 299.

In some embodiments, the second cover plate 296 is further provided with a third partition 2962 facing a side of the first wiring structure 292. The wire reel mechanism 290 further includes a third cover plate 297, and the third cover plate 297 covers a space between the first partition 2921 and the third partition 2962 to define an accommodating space for accommodating the first cable 298 wound around the first wiring structure 292.

Specifically, as shown in FIGS. 16 and 17, the third partition 2962 extends upward from the top of the second cover plate 296, and the third partition 2962 is located on the outer peripheral side of the first partition 2921. When the first cable 298 is wound around the first wiring structure 292, the displacement of the first cable 298 toward the inner side of the annular first partition 2921 is restricted by the first partition 2921. the displacement of the first cable 298 toward the outer side of the annular first partition 2921 is restricted by the third partition 2962. The third cover plate 297 is located above the first partition 2921 and the third partition 2962 and between the first partition 2921 and the third partition 2962, so the third cover plate 297 can restrict the vertical displacement of the first cable 298, preventing the first cable 298 from slipping, thereby improving the stability and practicality of the wire reel mechanism 290.

In some embodiments, as shown in FIG. 16, the wire reel mechanism 290 further includes a bottom plate 2901, covering a side of the second wiring structure 293 of the wire reel 291 to restrict the second cable 299 wound around the second wiring structure 293. The bottom plate 2901 is located below the second cable 299, supporting the second cable 299, and further enhancing the restriction on the second cable 299, thereby improving the stability of the wire reel mechanism 290.

According to a specific embodiment of the present disclosure, as shown in FIGS. 18 to 20, the air outlet structure 300 of this embodiment may include an inner air guide member 320 and an outer air guide member 330. The outer air guide member 330 cooperates with the inner air guide member 320 to define the second air outlet duct 310. An outer side wall of the inner air guide member 320 is provided with a first blocking portion 321 and a second blocking portion 322 disposed opposite to each other. The first blocking portion 321 is located at a position on the inner air guide member 320, the second blocking portion 322 is located at a position under the inner air guide member 320, the second air outlet duct 310 is divided by the first blocking portion 321 and the second blocking portion 322 into a third sub-duct 311 and a fourth sub-duct 312 distributed left and right, and the air flowing out of the first sub-duct 222 flows through the third sub-duct 311 and the fourth sub-duct 312 and flows out in a split manner.

Specifically, the first blocking portion 321 and the second blocking portion 322 are provided between the inner air guide member 320 and the outer air guide member 330, thereby dividing the second air outlet duct 310 into two sub-ducts on the left and right via the first blocking portion 321 and the second blocking portion 322, allowing air to flow out from the two sub-ducts in a split manner. The air flowing from the first sub-duct 222 into the second air outlet duct 310 flows out via the third sub-duct 311 and the fourth sub-duct 312 in a split manner, increasing the flow rate of the air, and allowing adjustment of the angle and range of air outflow by adjusting the position of the sub-ducts.

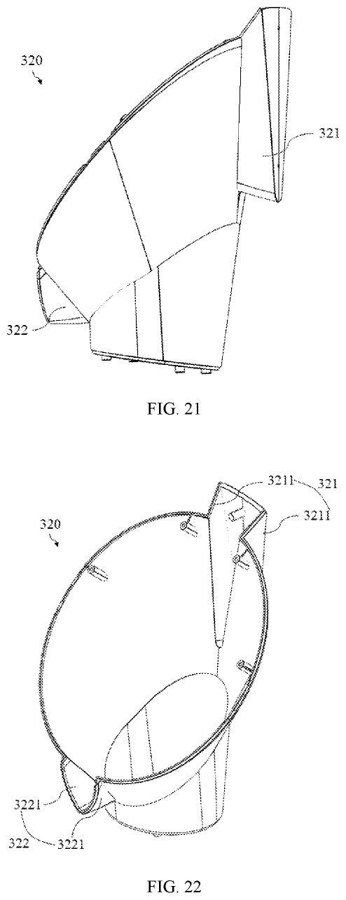

Specifically, as shown in FIGS. 21 and 22, the first blocking portion 321 of this embodiment may include two first flow guide surfaces 3211, the two first flow guide surfaces 3211 are planar, the bottoms of the two first flow guide surfaces 3211 are connected, and they gradually diverge upward at certain angles.

Specifically, the first blocking portion 321 of this embodiment begins to intersect at the middle-lower sections of the first flow guide surfaces 3211 and extends to the air outlet position. The two first flow guide surfaces 3211 are directly integrally formed with the inner air guide member 320. The outer sides of the two first flow guide surfaces 3211 provided with a side surface, connecting the outer sides of the two first flow guide surfaces 3211. The two first flow guide surfaces 3211 of this embodiment gradually diverge upward from the bottom at certain angles, guiding the air substantially along the direction of air flow, thus allowing the air to flow toward the air outlets on two sides.

According to a specific embodiment of the present disclosure, as shown in FIGS. 21 and 22, the second blocking portion 322 of this embodiment may include two second flow guide surfaces 3221, the two second flow guide surfaces 3221 are curved surfaces, the bottoms of the two second flow guide surfaces 3221 are connected, and they gradually diverge upward at certain angles and curve toward each other.

Specifically, the structure of the second blocking portion 322 in this embodiment is substantially the same as that of the first blocking portion 321, except that the second flow guide surfaces 3221 of the second blocking portion 322 are curved surfaces. The second blocking portion 322 also gradually diverges from the bottom to two sides and extends upward. The air flow may also flow along the second blocking portion 322 toward the air outlets on two sides. The first blocking portion 321 and the second blocking portion 322 allow the air in the second air outlet duct 310 to smoothly flow into the two air outlets and be blown out, without causing turbulence in the air within the second air outlet duct 310 that would disrupt the air flow.

Specifically, the air inlet direction of the second air outlet duct 310 of the air outlet structure 300 in this embodiment may be vertical, while the air outlet direction of the second air outlet duct 310 is inclined. That is, the air inlet direction and the air outlet direction of the second air outlet duct 310 form a certain angle. This allows the air outlet structure 300 to increase the sweeping area during rotation, improving purification efficiency.

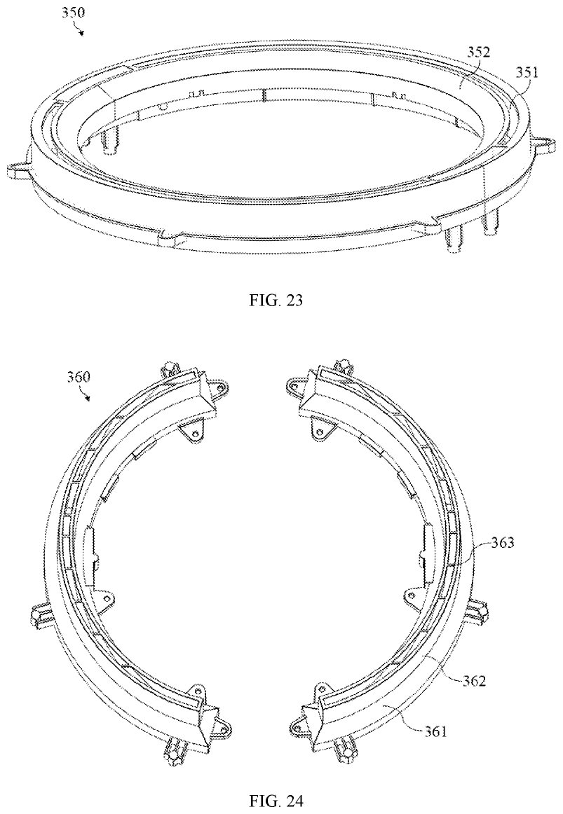

According to a specific embodiment of the present disclosure, as shown in FIGS. 18, 19, and 23, the air outlet structure 300 of this embodiment may further include a first shell 340 and an air outlet member 350. A surface of the first shell 340 is substantially an arc surface. The air outlet member 350 may include an annular air outlet 351, the air outlet 351 surrounding a periphery of the first shell 340. The air outlet member 350 is disposed downstream of the second air outlet duct 310 so that air in the second air outlet duct 310 is blown out via the air outlet 351. An inner side of the air outlet 351 of the air outlet member 350 is further provided with a curved surface 352, and an inner periphery of the curved surface 352 is connected to the periphery of the first shell 340. A curvature of the curved surface 352 is opposite to a curvature of the surface of the first shell 340, and the curved surface 352 extends inward from the air outlet 351 at an obtuse angle with an air outlet direction to prevent air blown out of the air outlet 351 from converging inward along the surface of the first shell 340.

This embodiment provides a curved surface 352 between the first shell 340 and the air outlet 351, where the curvature of the curved surface 352 is opposite to the curvature of the surface of the first shell 340, and the extension direction of the curved surface 352 forms an obtuse angle with the air outlet direction of the air outlet 351. The curved surface 352 is used to disrupt the phenomenon of the air outlet 351 converging inward along the surface of the first shell 340, thereby allowing the air output from the air outlet 351 of this embodiment to be unaffected by the first shell 340, avoiding convergence of the air from the air outlet 351 toward the surface of the first shell 340. This increases the air output area, increasing the mixing speed of air at different positions, and improving the user experience.

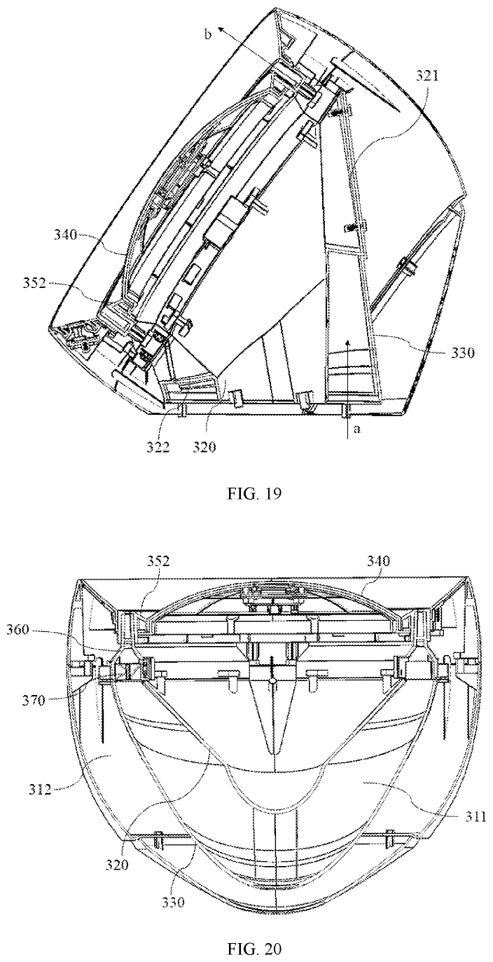

According to a specific embodiment of the present disclosure, as shown in FIGS. 19 and 24, the air outlet structure 300 of this embodiment may further include at least one flow guide member 360, the flow guide member 360 may include a mounting portion 361 and a flow guide portion 362, the mounting portion 361 is connected to the inner air guide member 320 and the outer air guide member 330 and is in communication with the second air outlet duct 310, the flow guide portion 362 is connected to the air outlet member 350, and air in the second air outlet duct 310 sequentially passes through the mounting portion 361 and the flow guide portion 362 and is blown out via the air outlet 351 of the air outlet member 350.

Specifically, the flow guide member 360 of this embodiment may include the mounting portion 361 and the flow guide portion 362, and since the second air outlet duct 310 in this embodiment is divided into two, there are also two flow guide members 360 in this embodiment.

The cross-sectional area of the mounting portion 361 in this embodiment is larger than that of the flow guide portion 362, thereby increasing the flow rate of air from the second air outlet duct 310 as it passes from the mounting portion 361 to the flow guide portion 362.

The mounting portion 361 can be connected and mounted with the inner air guide member 320 and the outer air guide member 330, and its interior can also accommodate other components, such as a heating component.

Specifically, the flow guide portion 362 of this embodiment is further provided with a plurality of flow guide blades 363 to define the direction of the air flow blown out of the air outlet 351.

Specifically, the air outlet 351 in this embodiment is designed to be inclined, so its air outlet direction is inclined upward. In this embodiment, the flow guide blades 363 can define the air outlet direction, allowing the air outlet direction to be changed based on the design. Specifically, the flow guide blades 363 in this embodiment are all inclined downward along the annular shape, so that the air blown out of the air outlet 351 is substantially in the horizontal direction, and when the air outlet 351 can rotate, it can further expand the sweeping range.

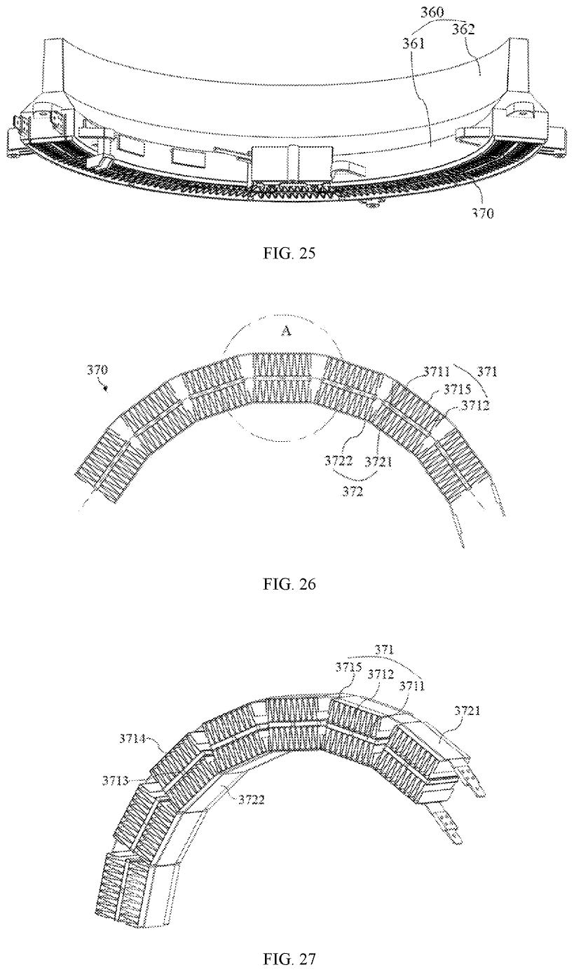

According to a specific embodiment of the present disclosure, as shown in FIG. 25, the air outlet structure 300 of this embodiment may further include at least one heating assembly 370, and the heating assembly 370 is disposed at the mounting portion 361, so that air blown out of the second air outlet duct 310 passes through the heating assembly 370 and is then blown out via the air outlet 351.

Specifically, the air outlet structure 300 of this embodiment may further include at least one heating assembly 370, allowing the air blown out of the air outlet structure 300 to be warm air, thereby avoiding the cooling of indoor air due to blowing of the air outlet structure 300 in winter, which otherwise would affect the user experience. Furthermore, since the air outlet structure 300 can blow warm air, the equipment (such as air purifiers or fans) applying the air outlet structure 300 can serve as heating equipment, thereby expanding the range of use of the equipment.

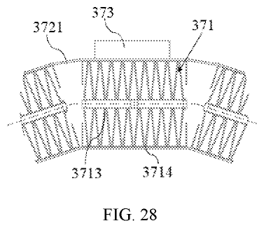

According to a specific embodiment of the present disclosure, as shown in FIGS. 26 to 28, each heating assembly 370 of this embodiment may include a plurality of heating modules 371 and a connecting member 372. Specifically, each heating module 371 of this embodiment may include at least one heating member 3711 and first heat dissipation members 3712 connected to two sides of the heating member 3711, where the heating member 3711 extends linearly, and the side of each first heat dissipation member 3712 connected to the heating member 3711 extends linearly. The connecting member 372 connects the plurality of heating modules 371 to form a structure matching a cross-section of the mounting portion 361.

Specifically, the heating module 371 of this embodiment may include a plurality of heating modules 371 and the connecting member 372, where the heating module 371 may include the heating member 3711 and the first heat dissipation member 3712. Generally, the heating member 3711 is a ceramic plate made of PTC material, where PTC stands for Positive Temperature Coefficient (positive temperature coefficient). PTC heating devices are typically made of PTC material, which has special resistance-temperature characteristics, meaning that within a certain temperature range, such material has resistance increasing with rising temperature and generates heat when electrified. The first heat dissipation member 3712 may be disposed beside the heating member 3711, in contact with the heating member 3711, to dissipate the heat generated by the heating member 3711. The first heat dissipation member 3712 may be a corrugated sheet or other heat dissipation structure, made of materials with good thermal conductivity, such as aluminum or copper.

More specifically, since the air outlet 351 in this embodiment is annular, the flow guide member 360 is also designed as an arc-shaped structure. And the heating assembly 370 is disposed at the mounting portion 361, so the heating assembly 370 also needs to be designed as an arc-shaped structure matching the mounting portion 361. Since the heating member 3711 in this embodiment is a ceramic plate, it is generally flat. To form it into an arc-shaped structure, in the prior art, the first heat dissipation members 3712 are directly shaped into an arc shape, which then contacts a plurality of interconnected heating members 3711 formed as a polyline, ultimately forming an arc-shaped heating assembly. However, such a design leads to poor contact between many first heat dissipation members 3712 and the heating member 3711 at the contact surface, resulting in poor heat dissipation and affecting the efficiency of heat dissipation. In this embodiment, the heating assembly 370 is formed by a plurality of heating modules 371 and a connecting member 372. Each heating module 371 may include at least one heating member 3711 and a first heat dissipation member 3712. Since the heating member 3711 extends linearly, the part of the first heat dissipation member 3712 in contact with the heating member 3711 also extends linearly, ensuring full contact between the first heat dissipation member 3712 and the heating member 3711, without affecting the heat dissipation effect of the first heat dissipation member 3712. Additionally, since the cross-section of the mounting portion 361 is arc-shaped, in this embodiment, the connecting member 372 can connect the plurality of heating modules 371 to form a shape matching the cross-section of the mounting portion 361. For example, although each heating module 371 extends linearly, the plurality of linearly extending heating modules 371 are connected to form a structure similar to or close to an arc, satisfying the arc structure while ensuring the heat dissipation effect.

As a specific embodiment of the present disclosure, each first heat dissipation member 3712 of this embodiment is bent to form a structure with a bent cross-section, where each first heat dissipation member 3712 includes a plurality of first bent portions 3713 close to the side of the heating member 3711, and the plurality of first bent portions 3713 are arranged linearly side by side, extending to ensure all first bent portions 3713 contact the heating member 3711.

Specifically, each first heat dissipation member 3712 of this embodiment is a bent structure, continuously bent to form a denser structure, increasing the contact area of the first heat dissipation member 3712 with air, thereby enhancing the heat dissipation performance of the first heat dissipation member 3712 and improving the heating efficiency of the heating assembly 370. Additionally, the plurality of first bent portions 3713 extend linearly, allowing all the first bent portions 3713 to contact the heating member 3711, further ensuring the heat dissipation effect and improving heating efficiency.

As another specific embodiment of the present disclosure, each first heat dissipation member 3712 of this embodiment may further include a plurality of second bent portions 3714 on the side away from the heating member 3711. Each heating module 371 may further include a second heat dissipation member 3715, where a side of each second heat dissipation member 3715 is connected to each second bent portion 3714 of the first heat dissipation member 3712, and another side of each second heat dissipation member 3715 is connected to the connecting member 372.

Specifically, the second heat dissipation member 3715 of this embodiment contacts each second bent portion 3714, ensuring that all heat from the first heat dissipation member 3712 can be transferred to the second heat dissipation member 3715. The connecting member 372 can be connected to the second heat dissipation members 3715, so that the second heat dissipation members 3715 form a structure matching the mounting portion 361. In this embodiment, the second heat dissipation member 3715 may be a metal sheet, and the connecting member 372 may also be a metal sheet, both having a certain ductility, so the second heat dissipation member 3715 and the connecting member 372 can be designed according to the direction and structure of the second bent portion 3714, ensuring full contact between the second heat dissipation member 3715 and the second bent portion 3714.

Preferably, the plurality of second bent portions 3714 may be arranged linearly side by side, so that the second heat dissipation member 3715 has a linear cross-section, while the connecting member 372 may be formed as a polyline type, with its linear segments contacting the second heat dissipation member 3715.

Specifically, in this embodiment, two side surfaces of the heating member 3711 are provided with first heat dissipation members 3712, so a second heat dissipation member 3715 is provided outside each first heat dissipation member 3712, and a connecting member 372 is provided outside each second heat dissipation member 3715. Therefore, the connecting member 372 may include a first connecting member 3721 and a second connecting member 3722, where the first connecting member 3721 and the second connecting member 3722 each connect the plurality of second heat dissipation members 3715 located on the same side of the heating member 3711.

Additionally, as a specific embodiment of the present disclosure, a driving impeller (not shown in the figure) may also be provided in the second air outlet duct 310 of the air outlet structure 300 of the air treatment device 100, where this driving impeller can work together with the driving member 240 in the first air outlet duct 221. When the driving member 240 in the first air outlet duct 221 is driven, it can cause air to flow toward the first sub-duct 222 and the second sub-duct 223, while the driving impeller in the second air outlet duct 310 can drive the air in the second air outlet duct 310 to be blown out by the air outlet structure 300, further increasing the air outlet speed and volume of the air outlet structure 300, and making the air outlet structure 300 produce a large air volume and blow air far, thereby enabling air blowing and purification at a distance.

Thus far, those skilled in the art should recognize that, although a plurality of exemplary embodiments of the present disclosure have been shown and described in detail herein, many other variations or modifications consistent with the principles of the present disclosure can still be directly determined or derived from the content disclosed in the present disclosure without departing from the spirit and scope of the present disclosure. Therefore, the scope of the present disclosure should be understood and deemed to cover all these other variations or modifications.

What is claimed is:

1. An air treatment device, characterized by comprising:
a machine body, wherein the machine body comprises a purification assembly, a flow guide assembly, and a valve assembly, wherein the purification assembly comprises a filter assembly and an air inlet duct defined by the filter assembly; the flow guide assembly is disposed on a side of the air inlet duct, and the flow guide assembly defines a first air outlet duct in communication with the air inlet duct; a first sub-duct and a second sub-duct are formed at a tail end of the first air outlet duct, air entering from the purification assembly first passes through the filter assembly for purification and then enters the first air outlet duct via the air inlet duct, and the air entering the first air outlet duct flows entirely through the first sub-duct and flows out, or the air entering the first air outlet duct flows through the first sub-duct and the second sub-duct and flows out in a split manner; and the valve assembly is disposed on a front side of the first sub-duct and the second sub-duct, and the valve assembly is controllably closed or opened to control the air to flow out entirely via the first sub-duct, or the air to flow through the first sub-duct and the second sub-duct and flow out in a split manner; and
an air outlet structure, rotatably connected to the machine body, wherein the air outlet structure comprises a second air outlet duct, and the second air outlet duct is in communication with the first sub-duct, so that all the air in the first sub-duct flows to the second air outlet duct and flows out.

2. The air treatment device according to claim 1, characterized in that the filter assembly comprises:
a first filter member, provided with mesh holes and defining the air inlet duct, and
a second filter member, disposed an outer side of the first filter member, so that external air first passes through the second filter member for filtration and then flows to the air inlet duct via the first filter member.

3. The air treatment device according to claim 1, characterized in that the valve assembly comprises:
a fixing member, comprising two cylindrical side plates nested with each other, and a connecting plate connecting the two side plates, wherein the connecting plate is provided with at least one first through hole, a structure enclosed by the side plate on an inner side is in communication with the first sub-duct, and the first through hole of the connecting plate is in communication with the second sub-duct; and
a moving member, disposed on a side of the connecting plate, wherein the moving member is provided with at least one second through hole, when the moving member is controllably moved to a position where the second through hole at least partially overlaps with the first through hole, the valve assembly is opened, and when the moving member is controllably moved to a position where the second through hole does not overlap with the first through hole at all, the valve assembly is closed.

4. The air treatment device according to claim 3, characterized in that the valve assembly further comprises:
a first motor; and
a first gear, connected to an output shaft of the first motor to rotate when driven by the first motor, wherein
an inner side of the moving member is provided with teeth meshing with the first gear, so that the moving member rotates when driven by the first motor, thereby opening or closing the valve assembly.

5. The air treatment device according to claim 1, characterized in that the machine body further comprises:
a second motor; and
a driving member, disposed in the air inlet duct or the first air outlet duct, wherein the driving member is connected to an output shaft of the second motor to rotate when driven by the second motor, thereby driving external air to flow through the purification assembly, the air inlet duct, and the first air outlet duct and flow out.

6. The air treatment device according to claim 5, characterized in that the machine body further comprises:
a third motor;
a second gear, connected to an output shaft of the third motor to rotate when driven by the third motor; and
a rotating member, being annular and connected to the air outlet structure, wherein an inner side of the rotating member is provided with teeth meshing with the second gear, and the third motor drives the second gear to rotate, thereby driving the rotating member and the air outlet structure to rotate.

7. The air treatment device according to claim 6, characterized in that
the machine body further comprises a wire reel mechanism, and the wire reel mechanism is disposed at an end of the third motor away from the second gear and rotates synchronously with the air outlet structure when driven by the third motor; and
the wire reel mechanism comprises a wire reel, wherein
the wire reel comprises:
a barrier panel, having a middle portion connected to the third motor and provided with a fourth through hole;
a first wiring structure, located on one side surface of the barrier panel; and
a second wiring structure, located on the other side surface of the barrier panel; wherein
a first cable and a second cable are wound around the first wiring structure and the second wiring structure respectively, and after one of the first cable and the second cable is led to another side of the wire reel via the fourth through hole, the first cable and the second cable are led out from a same side of the wire reel, wherein the first cable and the second cable are a power cable and a signal cable respectively.

8. The air treatment device according to claim 7, characterized in that
the first wiring structure comprises a first partition, the first partition is perpendicular to a plane of the barrier panel and formed as an annular structure, and the first cable is wound around the first partition; and
the first partition is provided with a first opening and a second opening, a first channel is provided between the first opening and the second opening, and the first cable wound around the first partition passes through a first fixing member disposed at the first opening and extends along the first channel to the second opening, and is led out by a second fixing member disposed at the second opening.

9. The air treatment device according to claim 8, characterized in that
the wire reel mechanism further comprises a first cover plate, and the first cover plate covers the first channel to restrict the first cable in the first channel.

10. The air treatment device according to claim 8, wherein
a side of the first partition away from the barrier panel has a first flange facing a side of the first cable.

11. The air treatment device according to claim 8, wherein
the second wiring structure comprises a second partition, and the second partition is perpendicular to the plane of the barrier panel and formed as an annular structure for winding the second cable; and
the second partition is provided with a third opening, a second channel is provided between the third opening and the through hole, and the second cable wound around the second partition passes through the third opening and enters the second channel, and is led to another side of the barrier panel via the through hole.

12. The air treatment device according to claim 11, wherein
a side of the second partition away from the barrier panel has a second flange facing a side of the second cable.

13. The air treatment device according to claim 8, wherein
the wire reel mechanism further comprises:
a second cover plate, wherein the second cover plate is annular and disposed at a periphery of the barrier panel of the wire reel, and cooperates with the barrier panel to isolate the first cable and the second cable; and the second cover plate is further provided with a third partition facing a side of the first wiring structure;
a third cover plate, wherein the third cover plate covers a space between the first partition and the third partition to define an accommodating space for accommodating the first cable wound around the first wiring structure; and
a bottom plate, covering a side of the second wiring structure of the wire reel to restrict the second cable wound around the second wiring structure.

14. The air treatment device according to claim 1, characterized in that
the air outlet structure comprises:
an inner air guide member; and
an outer air guide member, cooperating with the inner air guide member to define the second air outlet duct; wherein
an outer side wall of the inner air guide member is provided with a first blocking portion and a second blocking portion disposed opposite to each other; and the first blocking portion is located at a position above the inner air guide member, the second blocking portion is located at a position under the inner air guide member, the second air outlet duct is divided by the first blocking portion and the second blocking portion into a third sub-duct and a fourth sub-duct distributed left and right, and the air flowing out of the first sub-duct flows through the third sub-duct and the fourth sub-duct and flows out in a split manner.

15. The air treatment device according to claim 14, characterized in that the air outlet structure further comprises:
a first shell, with a surface being substantially an arc surface; and
an air outlet member, comprising an annular air outlet, wherein the air outlet surrounds a periphery of the first shell, and the air outlet member is disposed downstream of the second air outlet duct, so that air in the second air outlet duct is blown out via the air outlet; an inner side of the air outlet of the air outlet member is further provided with a curved surface, and an inner periphery of the curved surface is connected to the periphery of the first shell; and a curvature of the curved surface is opposite to a curvature of a surface of the first shell, and the curved surface extends inward from the air outlet at an obtuse angle with an air outlet direction to prevent air blown out of the air outlet from converging inward along the surface of the first shell.

16. The air treatment device according to claim 15, characterized in that
the air outlet structure further comprises at least one flow guide member, and the flow guide member comprises:
a mounting portion, wherein the mounting portion is connected to the inner air guide member and the outer air guide member and in communication with the second air outlet duct; and
a flow guide portion, wherein the flow guide portion is connected to the air outlet member, and the air in the second air outlet duct sequentially passes through the mounting portion and the flow guide portion and is blown out via the air outlet of the air outlet member; and the flow guide portion is further provided with a plurality of flow guide blades to define a direction of an air flow blown out of the air outlet.

17. The air treatment device according to claim 16, characterized in that
the air outlet structure further comprises at least one heating assembly, and the heating assembly is disposed at the mounting portion, so that air blown out of the second air outlet duct passes through the heating assembly and is then blown out via the air outlet; and
each heating assembly comprises:
a plurality of heating modules, wherein each of the heating modules comprises at least one heating member and first heat dissipation members connected to two sides of the heating member, the heating member extends linearly, and a side of each of the first heat dissipation members connected to the heating member extends linearly; and
a connecting member, connecting the plurality of heating modules to form a structure matching a cross section of the mounting portion.

18. The air treatment device according to claim 17, characterized in that
each of the first heat dissipation members is bent to form a structure with a bent cross-section, and each of the first heat dissipation members comprises:
a plurality of first bent portions close to a side of the heating member, and the plurality of first bent portions are arranged linearly side by side, so that all the first bent portions contact the heating member; and
a plurality of second bent portions away from a side of the heating member; wherein
each of the heating modules further comprises a second heat dissipation member, a side of each of the second heat dissipation members is connected to each of the second bent portions of the first heat dissipation member, and another side of each of the second heat dissipation members is connected to the connecting member.

19. The air treatment device according to claim 18, characterized in that
the connecting member comprises a first connecting member and a second connecting member, the first connecting member is connected to the second heat dissipation members on a same side of the plurality of heating modules, and the second connecting member is connected to the second heat dissipation members on another side of the plurality of heating modules.
